(19) United States
(12) Patent Application Publication
(10) Pub. No.: US 2011/0173759 A1
(43) Pub. Date: Jul. 21, 2011

(54) BICYCLE TOOL ASSEMBLY

(75) Inventor: KEIJI TAIGA, TOKYO (JP)

(73) Assignee: CROPS CO., LTD., Tokyo (JP)

(21) Appl. No.: 12/691,141

(22) Filed: Jan. 21, 2010

(51) Int. Cl. B26B 11/00

(52) U.S. Cl. 7/118

(57) ABSTRACT

A bicycle tool assembly includes a base having two base plates and a bar is connected between the two base plates. A tool set is pivotably connected to the bar. A chain tool assembly includes a first chain tool set and a second chain tool set, wherein the first chain tool set is pivotably connected to the bar and includes a clamp portion to clamp a chain. The second chain tool set is a board having a bent portion so as to be mounted to the tool set. The second chain tool can be removed from the base and is engaged with the first tool chain set. A push member is movably connected to the first chain tool set so as to reach the clamp portion to access the pins of the chain.

### FIELD OF THE INVENTION

The present invention relates to a tool assembly, and more particularly, to a tool assembly for bicycles and the tool assembly is easily used and includes multiple tools.

### BACKGROUND OF THE INVENTION

For maintenance purposes, most of the cyclists prepare some tools which generally include spanners, screwdrivers, nuts, bolts, sockets, spoke nipples tools, tire tools and chain tools.

The bicycle tool assemblies include two types which are specific-use and general-use, the specific-use tools are designed specifically for certain uses so that only professional bicycle manufacturers use them. The general-use tools are prepared for general cyclists so as to fix some minor problems when needed.

Taken the chain tool as an example, the chain tool is designed to disengage the pins from the link plates of the chain or to assemble the pins to the link plates. A first conventional chain tool assembly known to applicant includes a base with a first end and a second end which is located opposite to the first end. A positioning portion extends along the axial direction from the first end of the base and a recess is located corresponding to the second end of the base. A block extends from an underside of the recess. The positioning portion has a threaded hole and the block is engaged with the chain. A push member is threadedly connected to the threaded hole and includes an action end and an operation end. The action end is located corresponding to the block. A cover is mounted between the first and second ends of the base and removably covers the recess.

Another conventional chain tool assembly known to applicant includes a base and a tool set which includes multiple tools. A positioning pin is pivotably connected to an end of the base. A chain tool is removably connected to the base and includes a spanner wherein the chain tool can be removed from the base and the spanner is used to rotate the positioning pin to adjust the tightness between the base and the tools.

The first conventional chain tool assembly is focused on that when the pivotal portion contacts against the closed position on the base, the chain tool assembly can be reinforced in its structural strength. The second conventional chain tool assembly is focused on that the chain tool can be removably connected between two blocks of the base and does not affect the number of tools of the first and second tool sets.

However, for the second conventional tool assembly, the tools of the tool set and the chain tool are too close so that when operating the chain tool, the user is inconvenient to operate the chain tool.

The present invention intends to provide a chain tool that improves the shortcomings of the conventional chain tools.

### SUMMARY OF THE INVENTION

The present invention relates to a bicycle tool assembly and comprises a base having two base plates and at least one bar is connected between the two base plates. A tool set includes multiple tool members which are pivotably connected to the at least one bar so as to be pivoted about the at least one bar. A chain tool assembly includes a first chain tool set and a second chain tool set. The first chain tool set has a first end pivotably connected to the at least one bar and a clamp portion is formed on a second end of the first chain tool set. A push member is linearly and movably connected to the second end of the first chain tool set. The push member movably reaches the clamp portion. The second chain tool set is a board having a bent portion so as to be mounted to the tool set and engaged with the first tool chain set.

The primary object of the present invention is to provide a bicycle tool assembly which includes a first chain tool set which is pivoted out from the base of the tool assembly so as to clamp a chain. The pivoted first chain tool is located at a distance from the other tool sets.

Another object of the present invention is to provide a bicycle tool assembly which includes a first chain tool set and a second chain tool set, wherein the chain can be firmly positioned and the first chain tool set can be held by the user to assemble or disengage the chain.

Yet another object of the present invention is to provide a bicycle tool assembly which includes multiple different tools such as hexagonal tool, bottle opener and spoke nipple tool.

A further object of the present invention is to provide a bicycle tool assembly which includes space in the base so as to receive tools therein.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the bicycle tool assembly of the present invention;

FIG. 2 is another perspective view to show the bicycle tool assembly of the present invention;

FIG. 3 is an exploded view to show the bicycle tool assembly of the present invention;

FIG. 4 shows that the second chain tool is removed from the base of the bicycle tool assembly of the present invention;

FIG. 5 shows that the chain is positioned by the first and second chain tool sets of the bicycle tool assembly of the present invention, the first chain tool set is located at the first position;

FIG. 6 shows that the pin is pushed out from the link plates of the chain by the first chain tool set of the bicycle tool assembly of the present invention;

FIG. 7 is a cross sectional view to show that the base is rotated to move the push member forward;

FIG. 8 shows that the chain is positioned by the first and second chain tool sets of the bicycle tool assembly of the present invention, the first chain tool set is located at the second position;

FIG. 9 shows that the block on the first chain tool set is engaged with the second notch of the second chain tool set when the first chain tool set is located at the second position;

FIG. 10 is a cross sectional view to show that the base is rotated to move the push member forward to install the pin between the link plates of the chain;

FIG. 11 is an exploded view to show the base plate, the positioning and the tool of the base of the bicycle tool assembly of the present invention;

FIG. 12 shows that the bit is pivoted out from the base of the bicycle tool assembly of the present invention;

FIG. 13 shows that the bit is removed from the pivotal member of the tool set of the bicycle tool assembly of the present invention, and

FIG. 14 shows that the bit having two bit ends can be switched when connected with the tool set of the bicycle tool assembly of the present invention.

### DETAILED DESCRIPTION OF THE PREFERRED EMBODIMENT

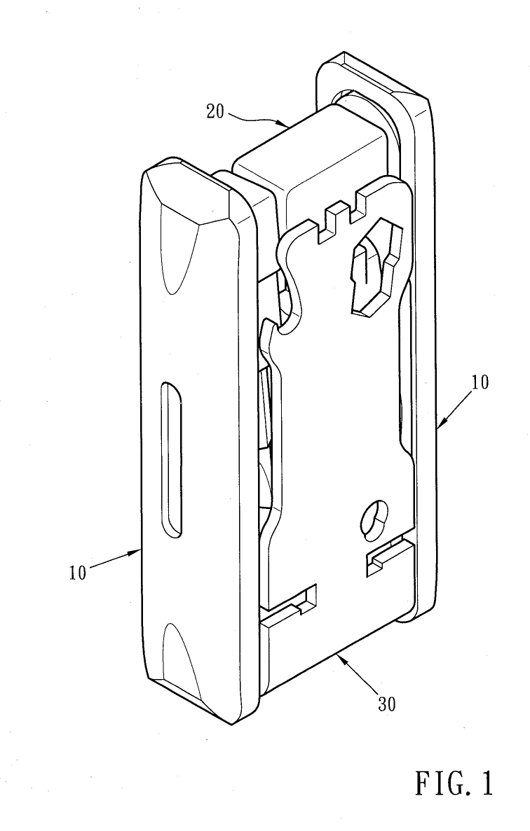

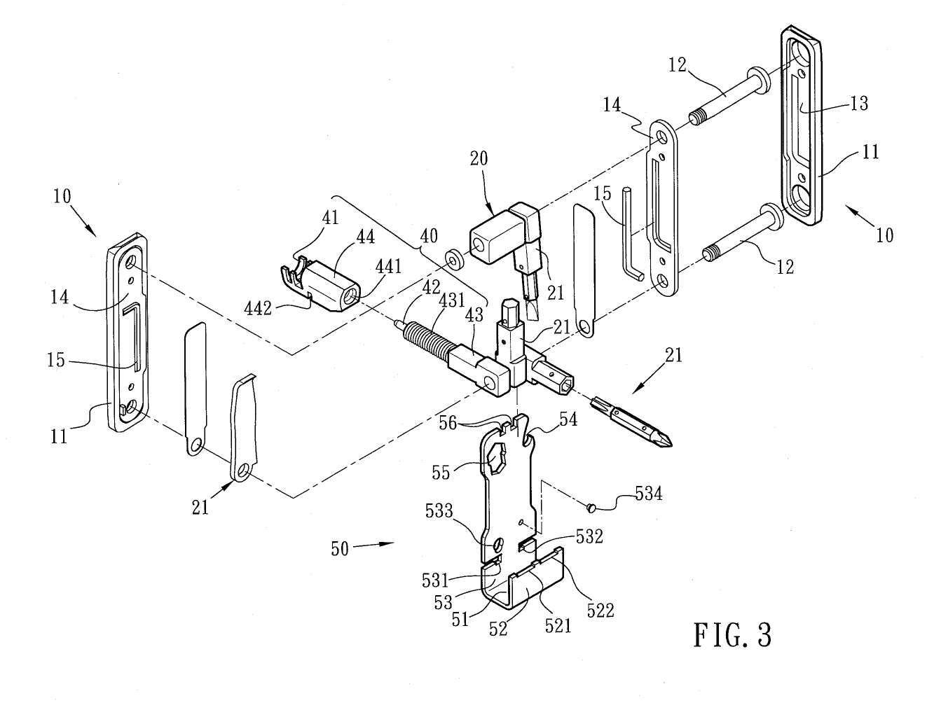

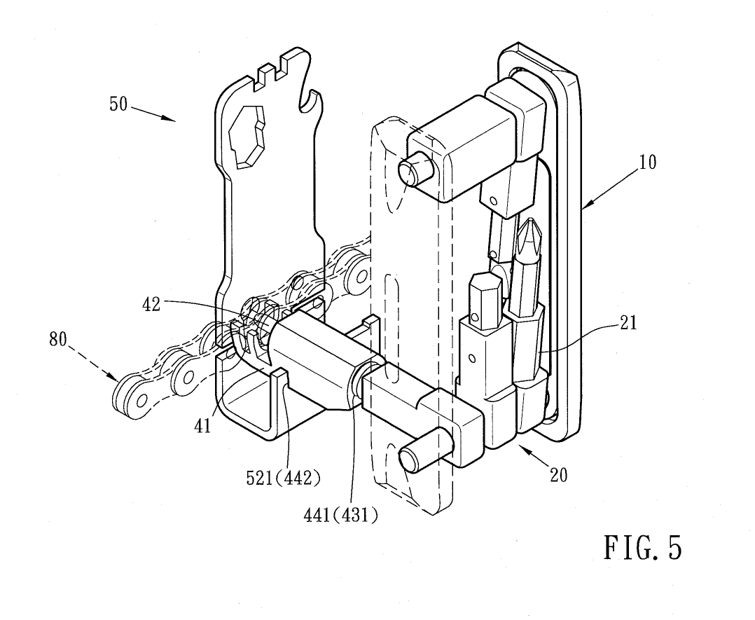

Referring to FIGS. 1 to 5, the bicycle tool assembly of the present invention comprises a base 10, a tool set 20 and a chain tool assembly 30. The chain tool assembly 30 includes a first chain tool set 40 and a second chain tool set 50.

The base 10 has two base plates 11 and two bars 12 are connected between the two base plates 11. Each base plate 11 has a space 13 defined in an inside thereof and a positioning portion 14 is engaged with the space 13 of each base plate 11. A tool 15 is connected to the positioning portion 14 and received in the space 13. The tool 15 can be a spanner, screwdriver or any hand tool.

The tool set 20 includes multiple tool members 21 which are pivotably connected to the bars 12 so as to be pivoted about the bars 12.

The first chain tool set 40 of the chain tool assembly 30 includes a first end pivotably connected to the bar 12 and a clamp portion 41 is formed on a second end of the first chain tool set 40. A push member 42 is linearly and movably connected to the second end of the first chain tool set 40. The push member 42 can movably reach the clamp portion 41. The second chain tool set 50 is a board having a bent portion so as to be mounted to the tool set 20. The second chain tool 50 can be engaged with the first tool chain set 40 and the clamp portion 41 can clamp a chain 80 and the push member 42 is located to access the chain 80.

The first chain tool set 40 includes a pivotal portion 43 which is pivotably connected to the bar 12 and a first guide portion 431 is connected to the pivotal portion 43. The push member 42 is located at a distal end of the first guide portion 431. The clamp portion 41 is connected to a first end of a guide member 44 and a second guide portion 441 is defined in the second end of the guide member 44. The second guide portion 441 is defined through the guide member 44. the first guide portion 431 is threadedly and movably connected to the second guide portion 441 so that the guide member 44 is linearly movable relative to the first guide portion 431. The push member 42 on the first guide portion 431 can be extended through the second guide portion 441 and reaches the clamp portion 41 or received in the second guide portion 441. A block 45 is located at the underside of the clamp portion 41 and a slot 442 is defined in an underside of the guide member 44 of the first chain tool set 40.

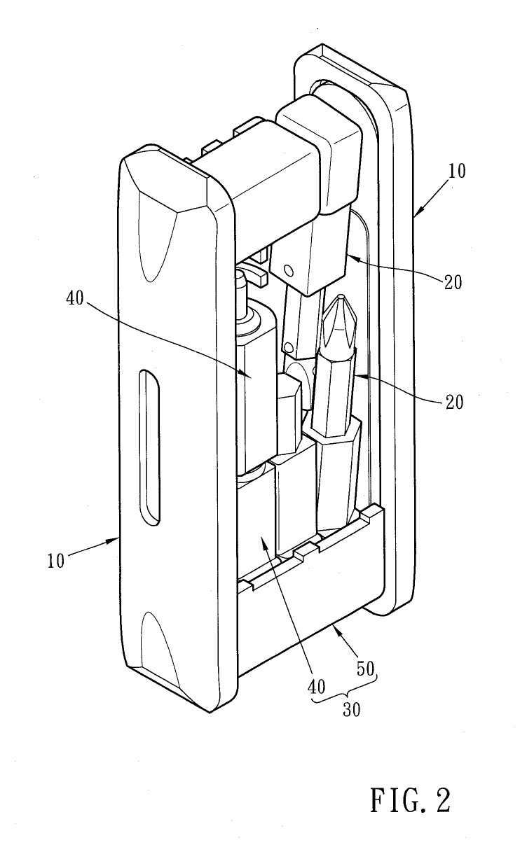

The bent portion of the board of the second chain tool set 50 includes a groove 51 with which the tool set 20 is engaged when the second chain tool set 50 is not in use as shown in FIGS. 1 and 2. The groove 51 is defined between a first wall 52 and a second wall 53, wherein the first wall 52 includes a first positioning place 521 and a second positioning place 522 defined in a top thereof, one of the first and second positioning places 521, 522 is engaged with the slot 442. The first positioning place 521 and the second positioning place 522 are two recesses and the slot 442 includes a pre-set depth.

The second wall 53 includes a first notch 531 and a second notch 532, the first notch 531 is located corresponding to the first positioning place 521 and the second notch 532 is located corresponding to the second positioning place 522. The first chain tool set 40 includes a guide member 44 and the clamp portion 41 is connected to the guide member 44. A block 45 is located at the underside of the clamp portion 41 so as to be engaged with one of the first and second notches 531, 532. The block 45 has a pre-set height so as to be engaged with one of the first and second notches 531, 532.

A hole 533 is defined through the board having the second wall 53 and located above the first notch 531. The hole 533 is located corresponding to the push member 42. A reinforcement piece 534 is connected to the board having the second wall 53 and located above the second notch 532. The reinforcement piece 534 is located corresponding to the push member 42. The second wall 53 further includes a bottle opener 54, a hexagonal tool 55 and a spoke nipple tool 56.

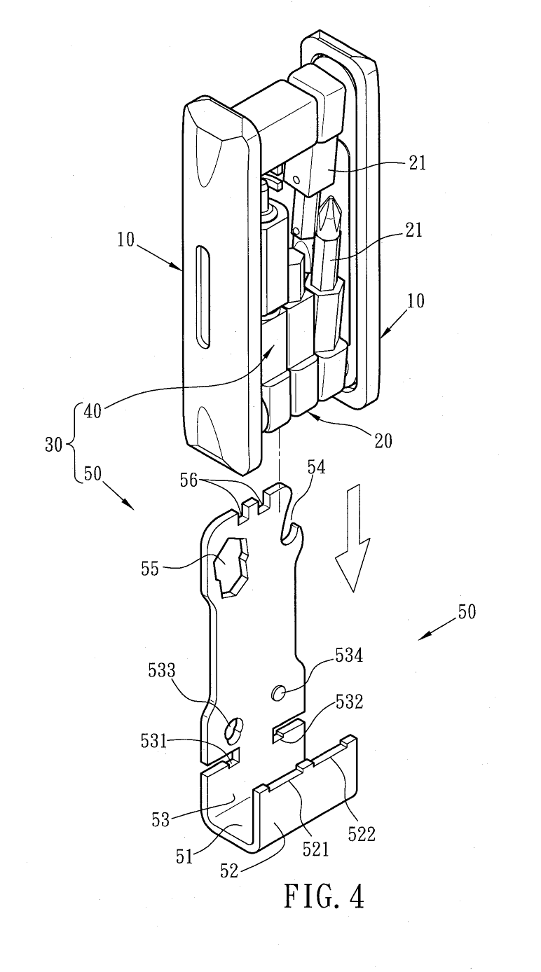

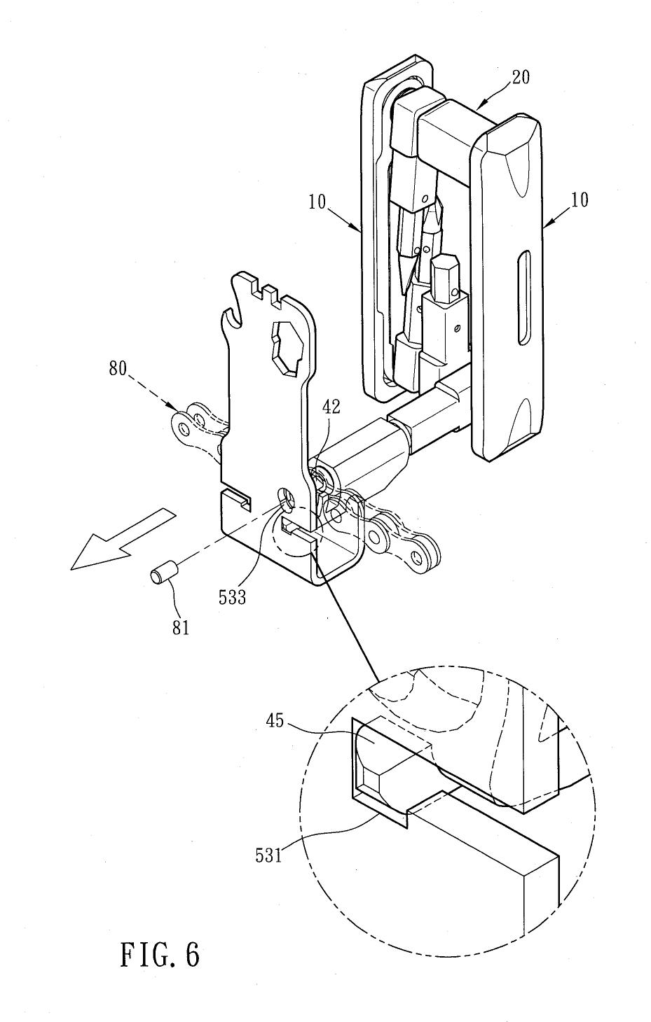

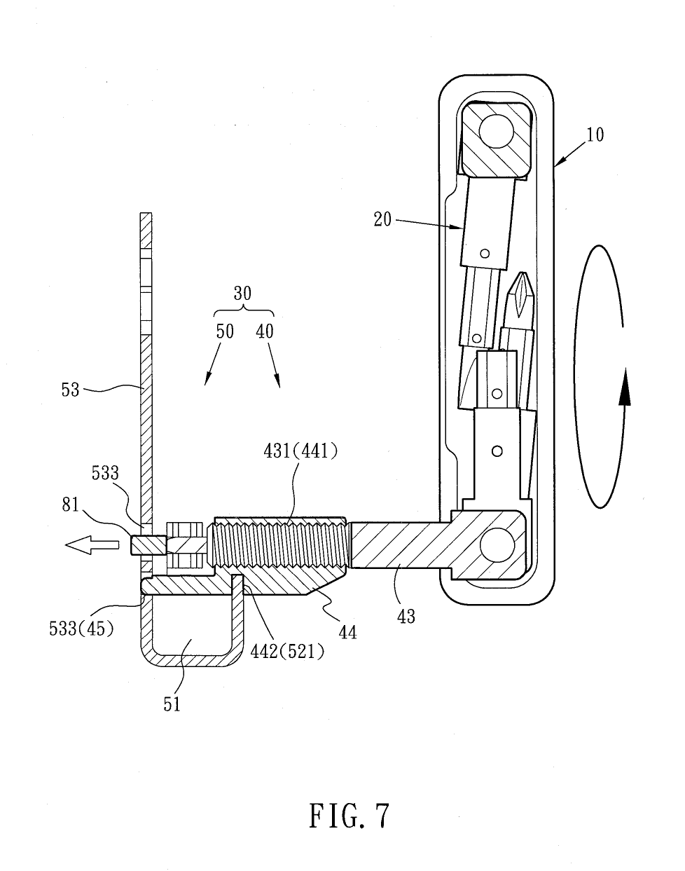

As shown in FIGS. 4 to 7, when the chain 80 needs to be adjusted, the second chain tool set 50 is removed from the tool set 20 and the first chain tool set 40 is pivoted outward to let the first positioning place 521 engage with the slot 442, the block 45 is engaged with the first notch 531. The push member 42 is located corresponding to the hole 533. The chain 80 is clamped by the clamp portion 41 and one of the pins 81 of the chain 80 is located corresponding to the push member 42. The user holds the second chain tool set 50 and rotates the base 10 together with the tool set 20, the first guide portion 431 is moved in the second guide portion 441 and toward the clamp portion 41. The push member 42 moves and pushes the pin 81 out from the hole 533 to disengage the chain 80.

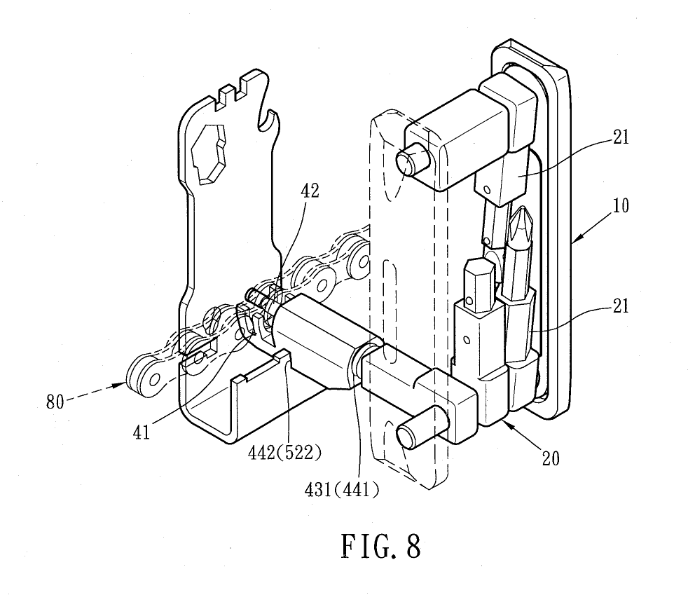

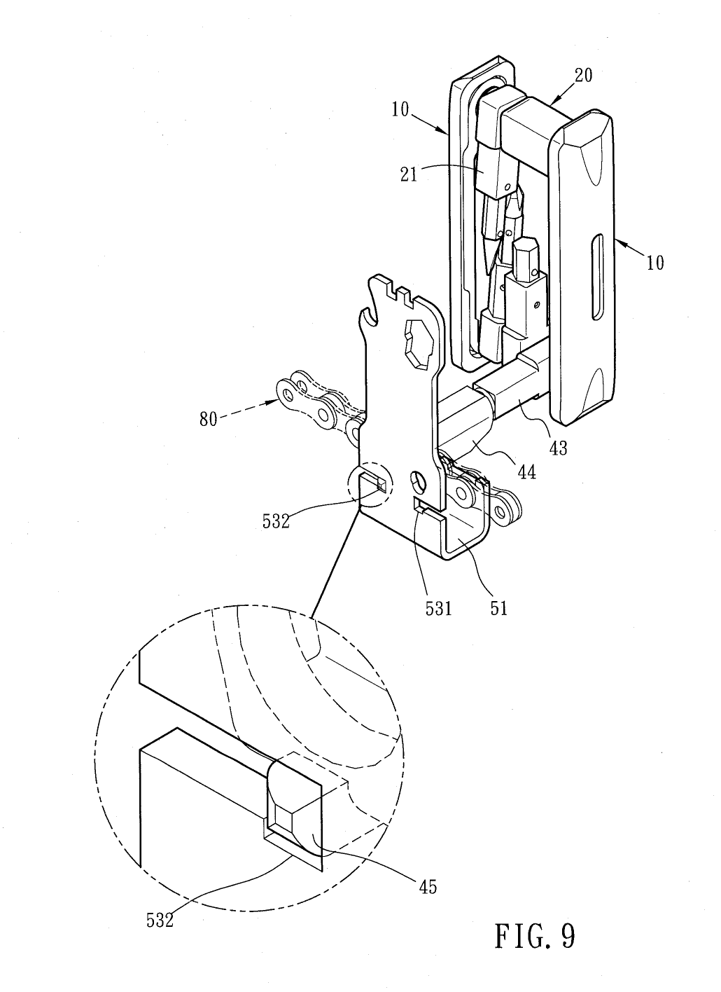

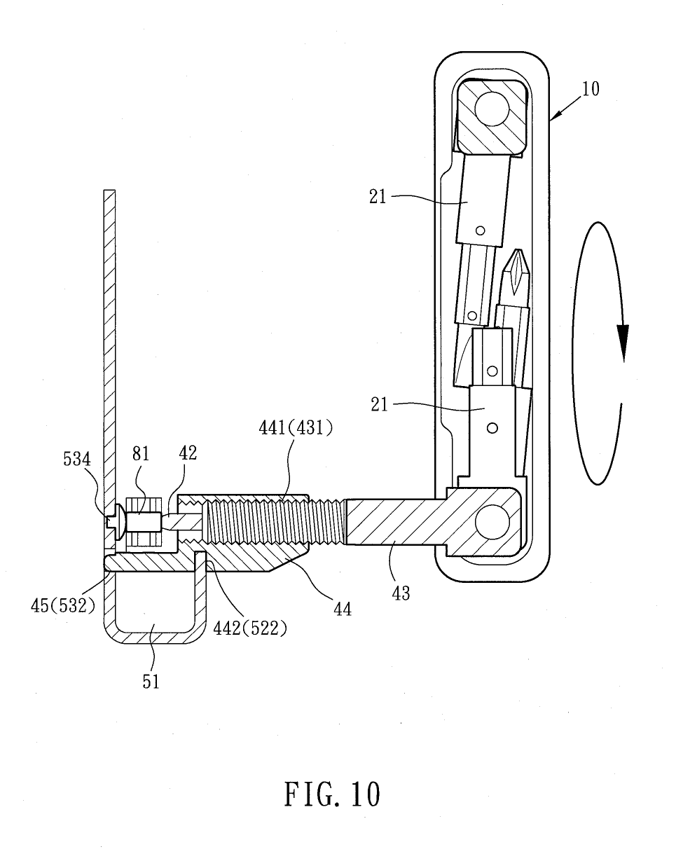

Referring to FIGS. 8 to 10, when reassembling the chain 80, the second chain tool set 50 is removed from the tool set 20 and the first chain tool set 40 is pivoted outward to let the second positioning place 522 engage with the slot 442, the block 45 is engaged with the second notch 532. The push member 42 is located corresponding to the reinforcement piece 534. The chain 80 is clamped by the clamp portion 41 and the pins 81 is inserted into the second guide portion 441 and located corresponding to the push member 42. The user holds the second chain tool set 50 and rotates the base 10 together with the tool set 20, the first guide portion 431 is moved in the second guide portion 441 and toward the clamp portion 41. The push member 42 moves and pushes the pin 81 until the pin 81 is pivotably connected between the link plates of the chain 80 and the pin 81 contacts against the reinforcement piece 534.

The first chain tool set 40 can be pivoted outward and located at a distance from the tool set 20 such that when operating the first chain tool set 40, the first chain tool set 40 does not affected by the tool members 21 of the tool set 20.

The first and second positioning places 521, 522 are designed to be engaged with the slot 442 so as to provide a good and firm relationship between the first and second chain tool sets 40, 50. This allows the user to easily rotate the base 10 to deal with the chain 80.

Besides, the first and second notches 531, 532 can be engaged with the block 45 to let the push member 42 precisely be in alignment with the pin 81 of the chain 80. This can ensure that the chain 80 will not be damaged by the push member 42. The hole 533 is designed to assist the pin 81 to drop from the chain 80. The reinforcement piece 534 is made of hard material which reduces wearing and assists the pin 81 to be precisely installed to the chain 80.

The second chain tool set 50 further includes bottle opener 54, the hexagonal tool 55, the spoke nipple tool 56 or a tire removal tool on the second wall 53 to provide more functions.

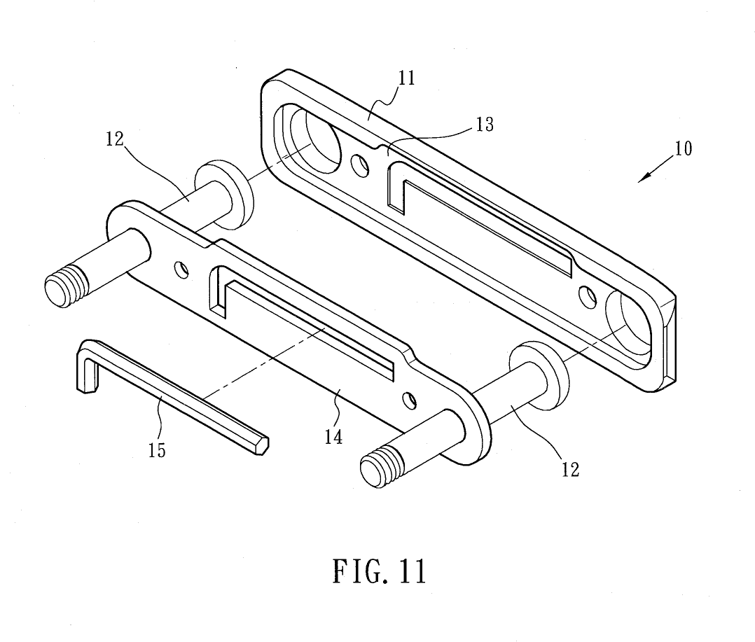

As shown in FIG. 11, each base plate 11 has a space 13 defined in an inside thereof and the positioning portion 14 is engaged with the space 13 of each base plate 11. The positioning portion 14 may have different and desired shapes of recess o as to receive tools 15 therein.

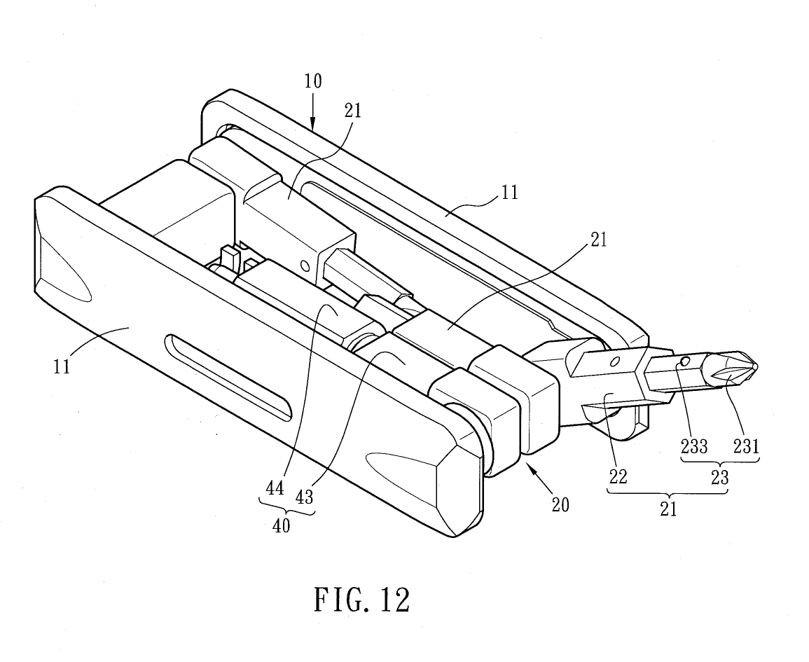

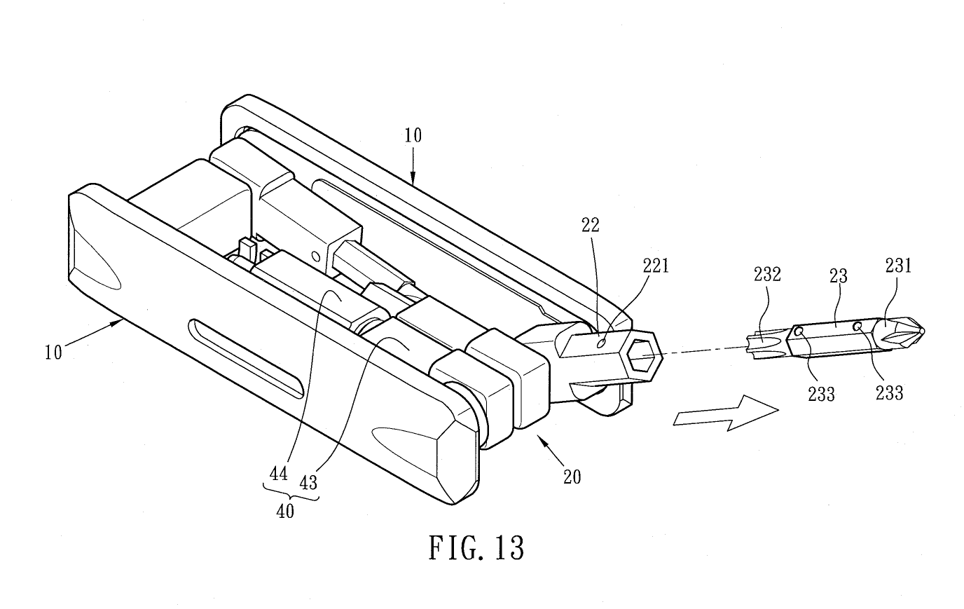

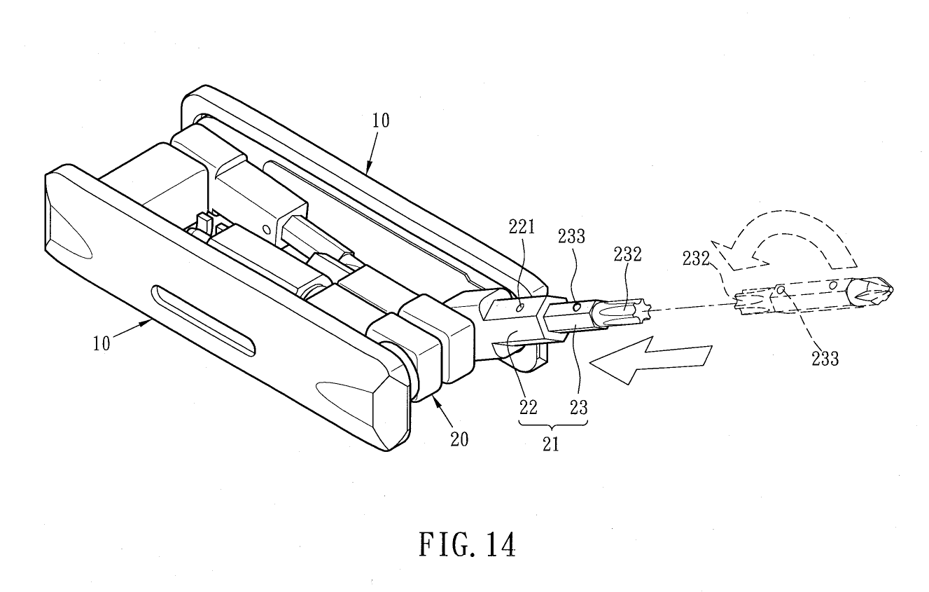

FIGS. 12 to 15 show that the tool members 21 each include a pivotal member 22 and a bit 23 is connected to the pivotal member 22, the bit 23 includes a first bit end 231 and a second bit end 232 on two ends of the bit 23. The first bit end 231 and the second bit end 232 on two ends of the bit 23 can be different shapes as known in the art. The user can switch the first and second bit ends 231, 232 by inserting the other bit end into the pivotal member 22. The bit 23 includes at least one first engaging portion 233 and at least one second engaging portion 221 is defined in the pivotal member 22. The at least one first engaging portion 233 is engaged with the at least one second engaging portion 221 to position the bit 23. In this embodiment, the first engaging portion 233 is a protrusion and the at least one second engaging portion 221 is a recess. The pivotal member 22 has a protrusion which is a hexagonal protrusion which can be used as a hexagonal bit.

While we have shown and described the embodiment in accordance with the present invention, it should be clear to those skilled in the art that further embodiments may be made without departing from the scope of the present invention.

What is claimed is:

1. A bicycle tool assembly comprising:
a base having two base plates and at least one bar connected between the two base plates;
a tool set including multiple tool members which are pivotably connected to the at least one bar so as to be pivoted about the at least one bar, and
a chain tool assembly including a first chain tool set and a second chain tool set, the first chain tool set having a first end pivotably connected to the at least one bar and a clamp portion formed on a second end of the first chain tool set, a push member linearly and movably connected to the second end of the first chain tool set, the push member movably reaching the clamp portion, the second chain tool set being a board having a bent portion so as to be mounted to the tool set and engaged with the first tool chain set, the clamp portion adapted to clamp a chain and the push member adapted to access the chain.

2. The assembly as claimed in claim 1, wherein each base plate has a space defined in an inside thereof and a tool is received in the space.

3. The assembly as claimed in claim 2, wherein a positioning portion is engaged with the space of each base plate and the tool is connected to the positioning portion.

4. The assembly as claimed in claim 1, wherein the tool members each include a pivotal member and a bit is connected to the pivotal member, the bit includes a first bit end and a second bit end on two ends of the bit.

5. The assembly as claimed in claim 4, wherein the bit includes at least one first engaging portion and at least one second engaging portion is defined in the pivotal member, the at least one first engaging portion is engaged with the at least one second engaging portion.

6. The assembly as claimed in claim 5, wherein the first engaging portion is a protrusion and the at least one second engaging portion is a recess.

7. The assembly as claimed in claim 4, wherein the pivotal member has a protrusion which is a hexagonal protrusion.

8. The assembly as claimed in claim 1, wherein the first chain tool set includes a pivotal portion which is pivotably connected to the at least one bar and a first guide portion is connected to the pivotal portion, the push member is located at a distal end of the first guide portion.

9. The assembly as claimed in claim 8, wherein the first chain tool set includes a guide member, the clamp portion is connected to a first end of the guide member and a second guide portion is defined in the second end of the guide member, the second guide portion is defined through the guide member, the first guide portion is movably connected to the second guide portion so that the guide member is linearly movable relative to the first guide portion, the push member on the first guide portion is extended through the second guide portion and reaches the clamp portion or received in the second guide portion.

10. The assembly as claimed in claim 9, wherein the first and second guide portions are threadedly connected to each other.

11. The assembly as claimed in claim 1, wherein the bent portion of the second chain tool set includes a groove with which the tool set is engaged, the groove is defined between a first wall and a second wall, the first wall includes a first positioning place and a second positioning place defined in a top thereof, the first chain tool set includes a slot defined in an underside thereof, one of the first and second positioning places is engaged with the slot.

12. The assembly as claimed in claim 11, wherein the first positioning place and the second positioning place are two recesses and the slot includes a pre-set depth.

13. The assembly as claimed in claim 11, wherein the second wall includes a first notch and a second notch, the first notch is located corresponding to the first positioning place and the second notch is located corresponding to the second positioning place, the first chain tool set includes a guide member and the clamp portion is connected to the guide member, a block is located at the underside of the clamp portion so as to be engaged with one of the first and second notches.

14. The assembly as claimed in claim 13, wherein the block has a pre-set height so as to be engaged with one of the first and second notches.

15. The assembly as claimed in claim 11, wherein a hole is defined through the board having the second wall and located above the first notch, the hole is located corresponding to the push member.

16. The assembly as claimed in claim 11, wherein a reinforcement piece is connected to the board having the second wall and located above the second notch, the reinforcement piece is located corresponding to the push member.

17. The assembly as claimed in claim 1, wherein the bent portion of the second chain tool set includes a groove which is defined by a first wall and a second wall, the second wall includes a bottle opener.

18. The assembly as claimed in claim 1, wherein the bent portion of the second chain tool set includes a groove which is defined by a first wall and a second wall, the second wall includes a hexagonal tool.

19. The assembly as claimed in claim 1, wherein the bent portion of the second chain tool set includes a groove which is defined by a first wall and a second wall, the second wall includes a spoke nipple tool.

20. The assembly as claimed in claim 1, wherein the bent portion of the second chain tool set includes a groove which is defined by a first wall and a second wall, the second wall includes a tire removal tool.
